(19) United States
(12) Patent Application Publication
(10) Pub. No.: US 2002/0061742 A1
(43) Pub. Date: May 23, 2002

(54) Method of managing radio resources in an interactive telecommunication network

(75) Inventors: Cedric Lapaille, Chatou (FR); Isabelle Espanol-Collet, Rueil (FR); Anne Magnier, Paris (FR); Regis Laval, Versailles (FR); Yann Sehedic, Vanves (FR)

Correspondence Address: SUGHRUE, MION, ZINN, MACPEAK & SEAS, PLLC., 2100 Pennsylvania Avenue, NW, Washington, DC, 20037-3213, US

(73) Assignee: ALCATEL

(21) Appl. No.: 09/975,960

(22) Filed: Oct. 15, 2001

(30) Foreign Application Priority Data
Oct. 16, 2000 (FR) 00 13 212

(51) Int. Cl. H04M 3/42

(52) U.S. Cl. 455/414; 455/427; 455/13.4; 455/12.1

(57) ABSTRACT

An interactive telecommunication network includes a plurality of terminals severally sharing the same available radio resource and is preferably of the type including at least one satellite. In a method of managing radio resources in the network, communication services and resources allocated by the network to a given connected terminal for uplink and/or downlink transmission are managed as a function of the value for the terminal tᵢ of a product α⁽ⁱ⁾ of the type:

α⁽ⁱ⁾=bandwidth rᵢx power pᵢ.

### CROSS-REFERENCE TO RELATED APPLICATIONS

This application is based on French Patent Application No. 00 13 212 filed Oct. 16, 2000, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to radiocommunications, for example to interactive telecommunication networks using or integrating satellites, and more particularly to managing the availability of resources and services for the various users of an interactive telecommunication network.

The present invention provides a method of managing radio resources, in particular the availability of radio resources, in an interactive telecommunication network, as well as a network and a terminal for implementing the radio resource management method.

1. Description of the Prior Art

A major question to be addressed by the designers of radiocommunication networks or systems, such as a satellite telecommunication system in particular, relates to the availability of resources and services, which contributes to the quality of service provided to the end user. Accordingly, several aspects have to be considered with a view to predicting propagation parameters, necessary in particular in designing Earth-space systems.

ITU-R Recommendation P.618-5 lists the effects to be taken into consideration and the model to be used to take them into account when designing Earth-space systems. A fixed margin is usually established in the clear sky links budget in the worst case scenario of use of the system, so as to anticipate and compensate degradation such as attenuation due to rain or a loss of free space, in accordance with the target availability of the system and the climatic area.

In a service area with a diameter of several hundred kilometers, propagation conditions can vary greatly and evolve differently from one place to another within said area covered by the system. A fixed margin implies that the capacity of channels is insufficiently used for a rather high percentage of the time.

However, there are situations in which the philosophy of designing a fixed margin into the links budget is highly unsatisfactory, and one characteristic example of this is provided by Ku or Ka band interactive satellite communication systems.

Given the variability of propagation conditions from one place to another, leading to a kind of statistical multiplexing of attenuation, one effective approach is to use a margin shared between active terminals within the service area, with a view to reducing the margin established to counter fading. That margin is generally decided on by assuming a small number of terminals subject to rainy weather within the service area.

However, the above solution does not prevent terminals subject to strong attenuation from affecting the quality of service for terminals connected to the same resource under clear sky conditions, or serious and unbalanced degradation of service when the number of terminals subject to rainy weather exceeds the number used to decide on the margin, which may have been the result of long-term statistical analyses.

The present invention aims in particular to alleviate the drawbacks previously cited through assistance with managing the consumption of the shared global margin with optimum conformance to set points for quality of service and availability of resources for each terminal.

### SUMMARY OF THE INVENTION

To this end, the present invention provides a method of managing radio resources in an interactive telecommunication network which includes a plurality of terminals severally sharing the same available radio resource and is preferably of the type including at least one satellite, in which method communication services and resources allocated by the network to a given connected terminal tᵢ for uplink and/or downlink transmission are managed as a function of the value for the terminal tᵢ of a product α⁽ⁱ⁾ of the type:

α⁽ⁱ⁾=bandwidth rᵢx power pᵢ,

with i varying from 1 to N, where N is the total number of terminals in the service area concerned.

The bandwidth term rᵢ preferably corresponds to the cumulative equivalent bandwidth of the connections of the terminal tᵢ, estimated at the time of accepting the call or connection concerned and the power term pᵢ corresponds to the average consumption of the terminal tᵢ, the value of pᵢ being determined periodically.

In one embodiment of the invention the allocation of communication services and resources to a connected terminal tᵢ is a function of the result of comparing the calculated value of the product α⁽ⁱ⁾, subject to a corresponding threshold value αₗᵢₘ⁽ⁱ⁾ in the form of a maximum bandwidth rᵢ x power pᵢ product, with the quantity of radio resources reserved for accepting the connection, augmented by a supplementary margin for achieving the availability of service required or fixed for the terminal tᵢ.

Thus the equivalent bandwidth rᵢ allocated to the terminal tᵢ is reduced by a factor α⁽ⁱ⁾ /

$${α}_{lim}^{( i )}$$

if the product α⁽ⁱ⁾ becomes greater than the product

$${α}_{lim}^{( i )}$$

(division of rᵢ by the latter factor) and, for a terminal tᵢ having a plurality of connections with different classes of service, the equivalent bandwidth reduction is shared between the various connections at random or in accordance with a predetermined hierarchical order.

Thus priority can be given to reducing the bandwidth(s) of the connection(s) using the most radio resources or those with reduced quality of service, for example.

In the event of serious reduction of bandwidth, the reduced bandwidth may no longer justify maintaining the connection concerned.

Thus the connection can be cut off or cleared down if its equivalent bandwidth falls below a lower threshold value rₘᵢₙ corresponding to the minimum binary bit rate allocated to a terminal tᵢ for the connection concerned, for example.

After the equivalent bandwidth rᵢ of a terminal tᵢ has been reduced beforehand, the equivalent bandwidth rᵢ is progressively returned to its normal value before reduction if the product α⁽ⁱ⁾ becomes less than the product

$${α}_{lim}^{( i )}$$

again.

To take into account also the overall situation in terms of radio resource capacity, a second phase of verification and adaptation, for a given radio resource, such as a carrier, shared by a group Gᵢ of several terminals tᵢ, the communication services and resources allocated by the network to the terminals tᵢ of the group Gᵢ are advantageously managed globally as a function of a parameter α^{Ti} defined by the equation:

$${α}^{Tj} = {\sum }_{G ( j )} {r}_{i} x {p}_{i} .$$

To be more precise, in this additional phase, the equivalent bandwidth rᵢ of all the terminals tᵢ of the group Gᵢ is reduced uniformly or in a differentiated manner or in a weighted manner if the parameter α^{Ti} exceeds a threshold value

$${α}_{lim}^{( {T}_{j} )}$$

corresponding to the capacity of the common radio resource shared by the terminals tᵢ of the group Gᵢ.

The equivalent bandwidth rᵢ of all the terminals tᵢ of the group Gᵢ is preferably reduced by a factor α^{Ti}/

$${α}_{lim}^{( {T}_{j} )}$$

(division of rᵢ by the latter factor).

To limit the reduction in quality of service to what is strictly necessary, the equivalent bandwidth reduction can be applied in a random or hierarchically predetermined manner to different terminals tᵢ of the group Gᵢ in succession, the product α^{Ti} is calculated again after each reduction of the equivalent bandwidth rᵢ for a terminal tᵢ, and continued application of the equivalent bandwidth reduction to the group Gᵢ halted immediately the following condition is verified:

$${α}^{{T}_{i}} \leq {α}_{lim}^{( {T}_{j} )} .$$

If the equivalent bandwidths rᵢ are reduced until they are equal to their respective minimum binary bit rates and the condition

$${α}^{{T}_{i}} \leq {α}_{lim}^{( {T}_{j} )}$$

is still not verified for all the terminals tᵢ of the group Gᵢ, all that remains is for the terminals tᵢ to be disconnected from the network to be chosen at random.

In the most comprehensive embodiment of the method according to the invention, and in a cyclic process, the bandwidths rᵢ of the terminals tᵢ connected to the network via the at least one satellite are managed individually at a first stage and the terminals tᵢ of the groups Gᵢ each associated with a shared radio resource are managed globally or in a grouped manner at a second stage.

The method is preferably applied to a code division multiple access satellite multimedia telecommunication network with automatic matching of the power transmitted from and to each terminal to the propagation conditions.

Implementation of the above method is based on the capacity of the algorithms used to allocate radio resources for transmitting traffic data to apply the reduction. For example, weighted circular permutation algorithms and weighted equitable queuing algorithms are compatible and usable with this kind of method.

It will be noted that the management method according to the invention is based on a plurality of fundamental criteria, with a view to achieving various objectives, namely:

isolation between the terminals: strong degradation of the propagation conditions of the radio channel of one terminal will not affect the terminals sharing the same radio resource (e.g. the same carrier).

equity: a lack of capacity will be assumed equally between the terminals.

guaranteed minimum binary bit rate: even in the eventuality of severe fading, the terminal can maintain a connection at a minimum binary bit rate.

On the basis of the above three points, it is possible to define two type of availability:

service availability: this is the percentage of the time for which the system or network is accessible with nominal performance. This means that during this time the system must comply with the quality of service requirements.

system access availability: this is the percentage of the time for which the system or network is accessible, even with degraded performance; the cause of the degraded performance of the link can be degraded propagation, for example caused by attenuation or scintillation due to heavy rain.

The present invention also provides an interactive satellite radiocommunication network or system providing communication channels and connections to a plurality of fixed or mobile terminals severally sharing the same radio resource made available by the network, wherein communication services and resources allocated to a given terminal tᵢ for uplink and/or downlink transmission are managed as a function of the value for the terminal tᵢ of a product α⁽ⁱ⁾ of the type:

α⁽ⁱ⁾=bandwidth rᵢ x power pᵢ.

The above system preferably uses the management method which is described above and one particular application of which is illustrated hereinafter, and to this end includes means for providing gateways suitable for packet-based multimedia traffic between terminals in different service areas, a central network or a base, radio resource control means providing in particular a connection acceptance control function, a media access control function, and a power control function, and means for managing margins which match equivalent bandwidths continuously or in a stepwise manner during the existence of connections as a function of the corresponding calculated values α⁽ⁱ⁾ and α^{Ti}.

The system advantageously further includes at least one traffic supervisor adapted to redistribute the radio resources allocated to each downlink transmission communication gateway and a dedicated logical signaling interface for each terminal tᵢ for adapting equivalent bandwidths and transmitting corresponding information to the traffic supervisor means.

Finally, the invention also provides a fixed or mobile telecommunication terminal forming part of a system or network of the type previously cited and adapted to implement the method described herein.

In what follows, the present invention is described in relation to one non-limiting example of its practical application, that application nevertheless constituting a preferred embodiment, integrated into a packet-based satellite communication system based on a generic architecture of the following kind.

A gateway in a service area is responsible for transporting data traffic and/or voice traffic between terminals in the service area and a central network. It accepts packet-based multimedia traffic and employs a plurality of functions to provide a quality of service for transport on the connection. It defines how radio resources are shared between the terminals and how radio resources are controlled in conformance with quality of service requirements.

Three main functions govern the use of radio resources: a connection acceptance control (CAC) function, a media access control (MAC) function, and a power control function.

The connection admission control function controls radio resources and decides whether to accept a connection at connection set-up time. This function assumes a capacity that takes into account a global margin shared by the terminals routed on the same radio resource (carrier or set of carriers), in order to apply fading countermeasures without degrading service.

The power control function measures the quality of the link for each terminal and adapts the power demand of each terminal to maintain the required cell error rate on the physical transmission medium.

The media access control function allocates a radio resource on a packet basis. It uses carrier load algorithms, quality of service obligation supervisors, and a return access protocol based on demand assignment multiple access (DAMA), the natures and modes of operation of which are known to the skilled person.

On the same principle as before, a fourth function known as the margin manager function has been added to adapt the equivalent bandwidth during the life of the connection in accordance with a strategy described hereinafter.

A practical embodiment of the method according to the invention applied to a “gateway to terminal” link is described in detail hereinafter. An embodiment applied to a “terminal to gateway” link is described in less detail.

The power is established on a terminal basis but the equivalent bandwidth is established on a connection basis. The following explanations describe in detail the reduction or the increase in the global equivalent bandwidth for the terminal and the sharing between the connections of a given terminal.

I) Gateway to Terminal Link

The following notation is used hereinafter:

rᵢ: equivalent bandwidth of the i^{th} terminal, which is the sum of the equivalent bandwidths of the connections estimated by the CAC function for accepting the call.

α⁽ⁱ⁾: the real bandwidth x power product for the i^{th} terminal. It is calculated from the average power consumption and is refreshed as soon as a new value of the average power consumption is available.

$${α}_{lim}^{( i )} :$$

the maximum bandwidth x power product for the i^{th} terminal. It corresponds to the quantity of radio resources reserved by the CAC function to accept the connection, augmented by the supplementary power margin necessary to achieve service availability for the i^{th} terminal, which can be considered as a virtual individual margin.

α^{T}: the global bandwidth x power product for all of the terminals of the carrier. It is given by the equation

$${α}^{T} = {\sum }_{SKT} {r}_{i} \cdot {p}_{l}$$

$$- {α}_{lim}^{T} :$$

the maximum bandwidth x power product for the carrier. It corresponds to the capacity of the carrier.

pᵢ: the average power consumption of the i^{th} terminal. It is calculated periodically from all of the powers provided by the power control function.

rₘᵢₙ: the minimum binary bit rate offered to each terminal.

Capacity Reduction

The first step individually verifies α⁽ⁱ⁾ against

$${α}_{lim}^{( i )} .$$

If the current value of α⁽ⁱ⁾ exceeds the limit for a terminal, the associated equivalent bandwidth rᵢ is reduced by a factor

$$\frac{{α}^{( i )}}{{α}_{lim}^{( i )}} ,$$

either continuously or in discrete steps to simplify the implementation.

If the equivalent bandwidth falls below rₘᵢₙ, the gateway is no longer capable of maintaining a minimum binary bit rate channel and the terminal is disconnected from the system.

The second step globally verifies the current value of α^{T} against

$${α}_{lim}^{T} .$$

If the current value of α^{T} exceeds the limit for the carrier, the equivalent bandwidth for all the terminals of the carrier is reduced by a factor

$$\frac{{α}^{T}}{{α}_{lim}^{T}} ,$$

For terminals below rₘᵢₙ, the gateway is no longer capable of maintaining the minimum binary bit rate channel and the terminal is disconnected from the system.

This second step is based on the radio hypothesis used to establish the collective margin. This assumes only a small number of terminals exposed to rainy weather, which can be considered as a rainy activity per terminal factor. This hypothesis leads to a collective margin much lower than the individual margin to achieve the same availability. However, the number of “rainy weather” terminals is sometimes greater than the number used to determine the margin. In this case, the collective processing reduces the equivalent bandwidth, even if each “rainy weather” terminal has not used up all of its individual margin.

The bandwidth reduction applies to the cumulative equivalent bandwidth of a terminal and must be shared between the connections of the terminal.

Accordingly, for a terminal with a plurality of connections with different classes of service, the invention proposes to start by progressively freeing up the high-performance connections. If this is not sufficient, the equivalent bandwidth of the connections that are not in real time is progressively reduced, and if the equivalent bandwidth of a connection falls below rₘᵢₙ, the connection is cleared down. If this is not sufficient, the equivalent bandwidth of the real time connections is progressively reduced to rₘᵢₙ in order to maintain the minimum binary bit rate channel.

On the other hand, for a terminal which has only one high-performance connection, the equivalent bandwidth is already established at rₘᵢₙ and in this case the terminal is disconnected only if the global bandwidth x power product exceeds

$${α}_{lim}^{T} .$$

Also, during the second step, it may happen that the equivalent bandwidth reduction for a small number of terminals is sufficient to return the global bandwidth x power product to

$${α}_{lim}^{T} .$$

The second step then begins by selecting a terminal to be processed at random.

Capacity Increase

A reduction in capacity can be considered as a transient event. Accordingly, at the end of the fading or absorption event, the capacity increases and the system returns to a state of availability of services. The equivalent bandwidth, which was reduced during the capacity reduction, is returned to its normal value.

The first step individually verifies the current value of α⁽ⁱ⁾ against

$${α}_{lim}^{( i )} .$$

If the current value of α⁽ⁱ⁾ falls below the limit for the terminal, the associated equivalent bandwidth is returned to the nominal equivalent bandwidth established by the CAC function.

The second step globally verifies the current value of α^{T} against

$${α}_{lim}^{T} .$$

If the current value of α^{T} falls below the limit for the carrier, the equivalent bandwidth of the terminals is progressively returned to the nominal value established by the CAC function.

The processing to reduce and increase the capacity can be performed automatically by a suitable program that manages modification of the equivalent bandwidth of the terminals and can have the following algorithmic structure, for example.

Individual Processing

1) Calculate α⁽ⁱ⁾ from:

α⁽ⁱ⁾=rᵢ* ·pᵢ

where rᵢ* is the nominal equivalent bandwidth established by the CAC function. rᵢ*=rᵢ when the power margins are not used up, but rᵢ*>rᵢ otherwise, so that rᵢ* must be memorized so that rᵢ can be returned to its original value after the reduction in capacity.

2) If

$${α}^{( i )} > {α}_{lim}^{( i )} ,$$

the situation is one of access to the availability of the system. A reduced equivalent bandwidth rᵢ is calculated from:

$${r}_{i} = {r}_{i}^{*} \cdot \frac{{α}_{lim}^{T}}{{α}^{( i )}}$$

If rᵢ<rₘᵢₙ, the terminal is disconnected from the access network.

3) If

$${α}^{( i )} \leq {α}_{lim}^{( i )} ,$$

rᵢ is returned to its nominal value rᵢ*.

Collective Processing

1) Calculate

$${α}_{1}^{T} \text{and} {α}_{2}^{T}$$

(on each clock cycle) from:

$${α}_{1}^{T} = {\sum }_{SKT} {r}_{i}^{*} \cdot {p}_{l} and {α}_{2}^{T} = {\sum }_{SKT} {r}_{i} \cdot {p}_{i}$$

2) If

$${α}_{2}^{T} < {α}_{lim}^{T} ,$$

following the new values of rᵢ defined during individual processing and the new values of pᵢ, then the bandwidths rᵢ are not modified.

3) If

$${α}_{2}^{T} \geq {α}_{lim}^{T} ,$$

a new value is calculated for the bandwidths rᵢ for all the terminals tᵢ, such that:

$${r}_{i}^{′} = {r}_{i} \times \frac{{α}_{lim}^{T}}{{α}_{2}^{T}} .$$

A terminal tᵢ is disconnected if rⁱᵢ<rₘᵢₙ.

Each time a new value of rⁱᵢ is determined, a new value of

$${α}_{2}^{T}$$

is calculated and the determination of a number rᵢⁱ is continued for as long as the condition

$${α}_{2}^{T} < {α}_{lim}^{T}$$

is not verified. The advantage of this solution is that the processing time can be limited as a function of the total number of terminals to be processed (real time processing).

Alternatively, each time a terminal tᵢ is disconnected,

$${α}_{2}^{T}$$

can be recalculated taking account only of that disconnection (the values rᵢ are used again and the values rⁱᵢ calculated up to this point are ignored), and the whole of the processing restarted.

$$4 ) If {α}_{1}^{T} > {α}_{lim}^{T} ,$$

the situation is one of access to the availability of the system. A terminal is chosen for which a reduced equivalent bandwidth rᵢ is calculated from the equation:

$${r}_{i} = {r}_{i}^{*} \frac{{α}_{lim}^{T}}{{α}^{T}}$$

The reduction is applied successively for the terminals, but after each calculation of a reduced equivalent bandwidth,

$${α}_{1}^{T}$$

must be calculated again from the equation:

$${α}_{1}^{T} = {\sum }_{SKT} {r}_{i} \cdot {p}_{i} .$$

If

$${α}_{1}^{T}$$

becomes less than

$${α}_{lim}^{T} ,$$

the reduction of the equivalent bandwidth is halted. If rᵢ=rₘᵢₙ for each value of i, a random choice is made to select the terminals to be disconnected.

5) If

$${α}_{2}^{T} \leq {α}_{lim}^{T} and {α}_{1}^{T} > {α}_{lim}^{T} , {r}_{i}$$

is returned to its nominal value rᵢ* successively for the terminals which have a reduced equivalent bandwidth. After each equivalent bandwidth is returned to its nominal value, α^{T} must be calculated again from the equation:

$${α}^{T} = {\sum }_{SKT} {r}_{i} \cdot {p}_{1} .$$

If α^{T} becomes greater than

$${α}_{lim}^{T} ,$$

returning the equivalent bandwidth to its nominal value is halted.

6) If

$${α}_{1}^{T} \leq {α}_{lim}^{T} ,$$

all the values of rᵢ are returned to their nominal value rᵢ*.

II. Terminal to Gateway Link

The method can be the same as that previously described for the gateway to terminal link, based on conserving the bandwidth x power product.

However, because of multiple access problems, the terminal may require a traffic supervisor for redistributing the radio resources allocated by the gateway to transmit traffic data on the gateway to terminal link. A particular logical signaling interface is constructed between the gateway and the terminal to make the reduction of the equivalent bandwidth efficient and to inform the algorithm of the traffic supervisor of the terminal of the reduction of rᵢ.

The return strategy is generally imposed by the constraint of having a very low capacity cost for transmitting the message informing the terminal of the equivalent bandwidth reduction. The number of reduction or increase steps will generally be reduced.

The two types of link (uplink and downlink) can be managed separately or in a more or less interleaved manner.

Accordingly, in a first embodiment of the invention, uplink radio resources management is independent of downlink radio resources management, except for situations of disconnection of terminals tᵢ, the consequences of which are taken into account in both management processes.

In a second embodiment, the method can manage uplink radio resources first and then downlink radio resources second, or vice versa, taking into account disconnections resulting from the management process performed first, and then repeating the management process performed first allowing for any disconnections occurring during the management process performed second.

Finally, in a third embodiment, uplink radio resources management can be correlated with downlink radio resources management, significantly reducing the bandwidths rᵢ of a given terminal tᵢ in the two transmission directions in the same manner.

Of course, the invention is not limited to the embodiment described, which can be modified, in particular from the point of view of the nature of its various components or by substituting technical equivalents, without departing from the scope of the protection afforded to the invention.

There is claimed:

1. A method of managing radio resources in an interactive telecommunication network which includes a plurality of terminals severally sharing the same available radio resource and is preferably of the type including at least one satellite, in which method communication services and resources allocated by said network to a given connected terminal for uplink and/or downlink transmission are managed as a function of the value for said terminal tᵢ of a product α⁽ⁱ⁾ of the type:
α⁽ⁱ⁾=bandwidth rᵢ x power pᵢ.

2. The method claimed in claim 1 wherein the bandwidth term rᵢ corresponds to the cumulative equivalent bandwidth of the connections of said terminal tᵢ, estimated at the time of accepting the call or connection concerned and the power term pᵢ corresponds to the average consumption of said terminal tᵢ, the value of pᵢ being determined periodically.

3. The method claimed in claim 1 wherein the allocation of communication services and resources to a connected terminal tᵢ is a function of the result of comparing the calculated value of the product α⁽ⁱ⁾, subject to a corresponding threshold value
$${α}_{lim}^{( i )}$$
in the form of a maximum bandwidth rᵢ x power pᵢ product, with the quantity of radio resources reserved for accepting the connection, augmented by a supplementary margin for achieving the availability of service required or fixed for said terminal tᵢ.

4. The method claimed in claim 3 wherein said equivalent bandwidth rᵢ allocated to said terminal tᵢ is reduced by a factor
$${α}^{( i )} / {α}_{lim}^{( i )}$$
if said product α⁽ⁱ⁾ becomes greater than said product
$${α}_{lim}^{( i )} .$$

5. The method claimed in claim 4 wherein, for a terminal tᵢ having a plurality of connections with different classes of service, the equivalent bandwidth reduction is shared between the various connections at random or in accordance with a predetermined hierarchical order.

6. The method claimed in claim 4 wherein a connection is cut off or cleared down if its equivalent bandwidth falls below a lower threshold value rₘᵢₙ corresponding to the minimum binary bit rate allocated to a terminal tᵢ for the connection concerned, for example.

7. The method claimed in claim 4 wherein, after the equivalent bandwidth rᵢ of a terminal tᵢ has been reduced beforehand, said equivalent bandwidth rᵢ is progressively returned to its normal value before reduction if said product α⁽ⁱ⁾ becomes less than said product
$${α}_{lim}^{( i )}$$
again.

8. The method claimed in claim 1 wherein, for a given radio resource, such as a carrier, shared by a group Gᵢ of several terminals tᵢ, the communication services and resources allocated by said network to said terminals tᵢ of said group Gᵢ are managed globally as a function of a parameter α^{Ti} defined by the equation:
$${α}^{{T}_{j}} = {\sum }_{G ( i )} {r}_{i} \times {p}_{i} .$$

9. The method claimed in claim 8 wherein the equivalent bandwidth rᵢ of all said terminals tᵢ of said group Gᵢ is reduced uniformly or in a differentiated manner or in a weighted manner if said parameter α^{Ti} exceeds a threshold value
$${α}_{lim}^{( {T}_{j} )}$$
corresponding to the capacity of the common radio resource shared by said terminals tᵢ of said group Gᵢ.

10. The method claimed in claim 9 wherein said equivalent bandwidth rᵢ of all said terminals tᵢ of said group Gᵢ is reduced by a factor
$${α}^{{T}_{i}} / {α}_{lim}^{( {T}_{j} )} .$$

11. The method claimed in claim 9 wherein the equivalent bandwidth reduction is applied in a random or hierarchically predetermined manner to different terminals tᵢ of said group Gᵢ in succession, said product α^{Ti} is calculated again after each reduction of said equivalent bandwidth rᵢ for a terminal t₁, and continued application of said equivalent bandwidth reduction to said group Gᵢ is halted immediately the following condition is verified:
$${α}^{{T}_{i}} \leq {α}_{lim}^{( {T}_{j} )} .$$

12. The method claimed in claim 9 wherein, if the equivalent bandwidths rᵢ are reduced until they are equal to their respective minimum binary bit rates and the condition
$${α}^{{T}_{i}} \leq {α}_{lim}^{( {T}_{j} )}$$
is still not verified, for all said terminals tᵢ of said group Gᵢ, the terminals tᵢ to be disconnected from said network are chosen at random.

13. The method claimed in claim 8 wherein, in a cyclic process, said bandwidths rᵢ of said terminals tᵢ connected to said network via said at least one satellite are managed individually at a first stage and said terminals tᵢ of said groups Gᵢ each associated with a shared radio resource are managed globally or in a grouped manner at a second stage.

14. The method claimed in claim 1 wherein said network is a code division multiple access satellite multimedia telecommunication network with automatic matching of the power transmitted from and to each terminal to the propagation conditions.

15. The method claimed in claim 1 wherein the uplink radio resource and downlink radio resource management processes are independent of each other except in the situation of disconnection of terminals tᵢ, the consequences of which are taken into account in said two management processes.

16. The method claimed in claim 14 wherein said uplink radio resources are managed at a first stage and said downlink radio resources are managed at a second stage, or vice versa, taking into account disconnections resulting from the management process performed first, after which said management process performed first is performed again, taking into account any disconnections that have occurred during the management process performed second.

17. The method claimed in claim 14 wherein uplink radio resource management and downlink radio resource management are correlated, in particular by reducing the bandwidths rᵢ of a given terminal tᵢ in the same manner in both transmission directions.

18. An interactive satellite radiocommunication network providing communication channels and connections to a plurality of fixed or mobile terminals severally sharing the same radio resource made available by said network, wherein communication services and resources allocated to a given terminal tᵢ for uplink and/or downlink transmission are managed as a function of the value for said terminal tᵢ of a product α⁽ⁱ⁾ of the type:
α⁽ⁱ⁾=bandwidth rᵢ x power pᵢ.

19. The network claimed in claim 18 including means for providing gateways suitable for packet-based multimedia traffic between terminals in different service areas, a central network or a base, radio resource control means providing in particular a connection acceptance control function, a media access control function, and a power control function, and means for managing margins which adapt equivalent bandwidths continuously or in a stepwise manner during the existence of connections as a function of the corresponding calculated values α⁽ⁱ⁾ and α^{Ti}.

20. The network claimed in claim 18 further including at least one traffic supervisor adapted to redistribute the radio resources allocated to each downlink transmission communication gateway and a dedicated logical signaling interface for each terminal tᵢ for adapting equivalent bandwidths and transmitting corresponding information to said traffic supervisor means.

21. A fixed or mobile telecommunication terminal that is part of a network as claimed in claim 18 and which is adapted to implement a management method as claimed in claim 1.
